(19) United States
(12) Patent Application Publication
(10) Pub. No.: US 2006/0103828 A1
(43) Pub. Date: May 18, 2006

(54) Adjustable illumination blade assembly for photolithography scanners

(76) Inventor: Douglas J. David, Boise, ID (US)

Correspondence Address: Kevin D. Martin;Micron Technology, Inc., MS 1-525, 8000 S Federal Way, Boise, ID, 83716, US

(21) Appl. No.: 10/992,395

(22) Filed: Nov. 17, 2004

(51) Int. Cl. G03B 27/54

(52) U.S. Cl. 355/67; 355/53

(57) ABSTRACT

A method and structure for providing adjustable optical lithography illumination comprises a blade which can be customized to provide a desired light pattern. The adjustable blade can be selectively configured to optimize a light pattern during development of a photolithographic process, then the optimized pattern can be transferred to a diffractive optical element or other light shaping means for production. Descriptions and depictions of specific adjustable blades are provided.

### FIELD OF THE INVENTION

This invention relates to the field of semiconductor manufacture and, more particularly, to photolithography equipment useful during the formation of a semiconductor device.

### BACKGROUND OF THE INVENTION

During the formation of a semiconductor device many features such as conductors (word lines, digit lines), electrical contacts, and other physical features are commonly formed from, into, and over a semiconductor wafer. A goal of semiconductor device engineers is to form as many of these features in a given area as possible to increase yield percentages and to decrease device size and manufacturing costs.

All heterogeneous structures on a semiconductor wafer requires lithography. Optical lithography, the lithographic method most used in leading-edge wafer processing, comprises projecting coherent light of a given wavelength from an illumination source (illuminator) through a quartz photomask or reticle having a chrome pattern thereon, and imaging that pattern onto a photoresist-coated wafer. The light chemically alters the photoactive photoresist and allows the exposed photoresist (if positive resist is used) or the unexposed photoresist (if negative resist is used) to be rinsed away using a developer.

With decreasing feature sizes the limits of optical lithography are continually being tested and lithographic methods and materials are continually being improved through various developments, generally referred to as resolution enhancement techniques (RET's). RET's alter various aspects of the lithographic process to optimize the size and shape of a desired feature. For example, the wavelength of light used to expose the photoresist may be decreased, as longer wavelengths cannot resolve the decreasing feature sizes. The wavelength used with lithographic equipment has decreased from 365 nanometers (nm) in the mid-1980's to the current standard of 193 nm. Another RET includes optical proximity correction, which uses subresolution changes in the chrome pattern on the photomask or reticle to optimize the shape of the light focused on the photoresist. Without optical proximity correction, the chrome pattern is a scaled shape of the pattern which is to be produced. With very small features a scaled shape does not produce the desired pattern due to diffraction effects. However, the chrome photomask features can be modified in a manner that attempts to account for these diffraction effects. U.S. Pat. No. 6,245,468 by Futrell et al., assigned to Micron Technology, Inc. and incorporated herein by reference as if set forth in its entirety, describes an optical proximity correction apparatus and method. A third RET uses unequal photomask thickness of the quartz on which the chrome is formed at selected locations between the chrome to provide a phase-shift photomask. Phase shifting sets up destructive interference between adjacent light waves to enhance the pattern formed on the photoresist.

Another resolution enhancement technique is off-axis illumination, which improves the resolution of repeating patterns found in semiconductor device manufacture. FIG. 1 depicts an apparatus comprising off-axis illumination, and depicts an illuminator 10 comprising a laser which provides a coherent light source 12, a diffractive optical element (DOE) 14, a zoom axicon 16, a first reflector 18, a blade 20, an optical homogenizer 22, a second reflector 24, a vertical photomask 26, a lens 28, and a wafer 30 comprising a layer of photoresist (not individually depicted). It should be noted that the simultaneous use of a blade 20 and a DOE 14 as depicted in FIG. 1 is for illustration purposes only, as the use of one typically excludes the use of the other. A structure similar to the one depicted in FIG. 1, as well as the other RET's previous listed, are described and illustrated in A Little Light Magic, IEEE Spectrum, September 2003, pp. 34-39.

During research and development of a production process, simulation software is often used to predict the accuracy of an optical pattern for use with an illumination source on a stepper or scanner. As with circuit simulation, this software closely emulates the actual output which will be produced, but is not an exact representation and some trial and error manipulation of patterns is often necessary. To tune the illumination source pattern, a number of blades having different fixed patterns are used. In operation, each fixed blade is sequentially and manually inserted into the illumination path by a technician or engineer to determine the best illumination pattern for the mask or reticle being used. Changing a blade requires the engineer to first idle the equipment, manually replace the blade, initialize and calibrate the equipment, then return the tool to production. DOE's may also be used to determine a workable pattern and in fact function better than blades because they do not limit illumination intensity and can be placed into the light path by the equipment itself, however they are very expensive and have a construction lead time of several weeks. In practice, blades are used to determine the best pattern, then a DOE having the correct pattern based on testing using blades is ordered and used in production.

A method and structure for decreasing the time and expense of selecting a suitable DOE pattern during research and development of a production photolithography process would be desirable.

### SUMMARY OF THE INVENTION

The present invention provides a new method and apparatus which, among other advantages, decreases the time and expense required to select a suitable diffused optical element pattern during the research and development of a photolithography process to form a semiconductor device. In accordance with one embodiment of the invention, an adjustable blade mechanism is used which may be adjusted remotely through equipment software. This eliminates the requirement for manual replacement of one blade with another by an engineer or technician.

Advantages will become apparent to those skilled in the art from the following detailed description read in conjunction with the appended claims and the drawings attached hereto.

### BRIEF DESCRIPTION OF THE DRAWINGS

FIG. 1 depicts a conventional optical lithography apparatus;

FIG. 2 depicts a computer controller connected to an adjustable optical lithography blade apparatus;

FIG. 3 depicts a front view of a first embodiment of an adjustable blade apparatus;

FIG. 4 is an isometric view of the blade arms and gears for adjusting the arms;

FIG. 5 is an embodiment of a frame to which the arms of the blade are mounted;

FIG. 6 is a side view, and FIG. 7 is a front view, of another embodiment of the blade apparatus having arms which are adjustable using electromagnets;

FIG. 8 is a front view of a quadrupole blade apparatus;

FIG. 9 is a front view of an annulus blade apparatus;

FIG. 10 is an isometric depiction of various components which may be manufactured using devices formed using an embodiment of the present invention; and

FIG. 11 is a block diagram of an exemplary use of the invention to form part of a transistor array in a memory device.

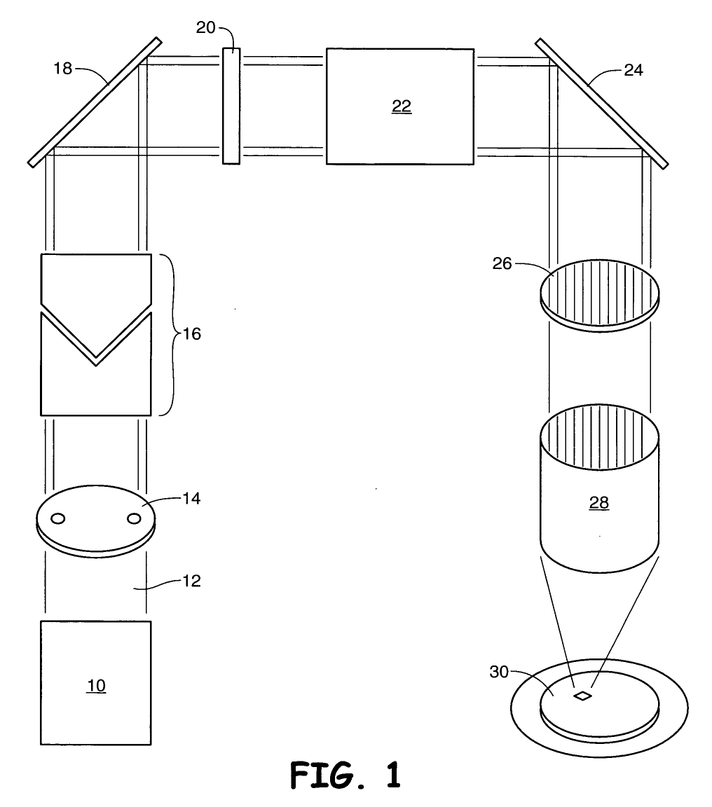

It should be emphasized that the drawings herein may not be to exact scale and are schematic representations. The drawings are not intended to portray the specific parameters, materials, particular uses, or the structural details of the invention, which can be determined by one of skill in the art by examination of the information herein.

### DETAILED DESCRIPTION OF THE PREFERRED EMBODIMENT

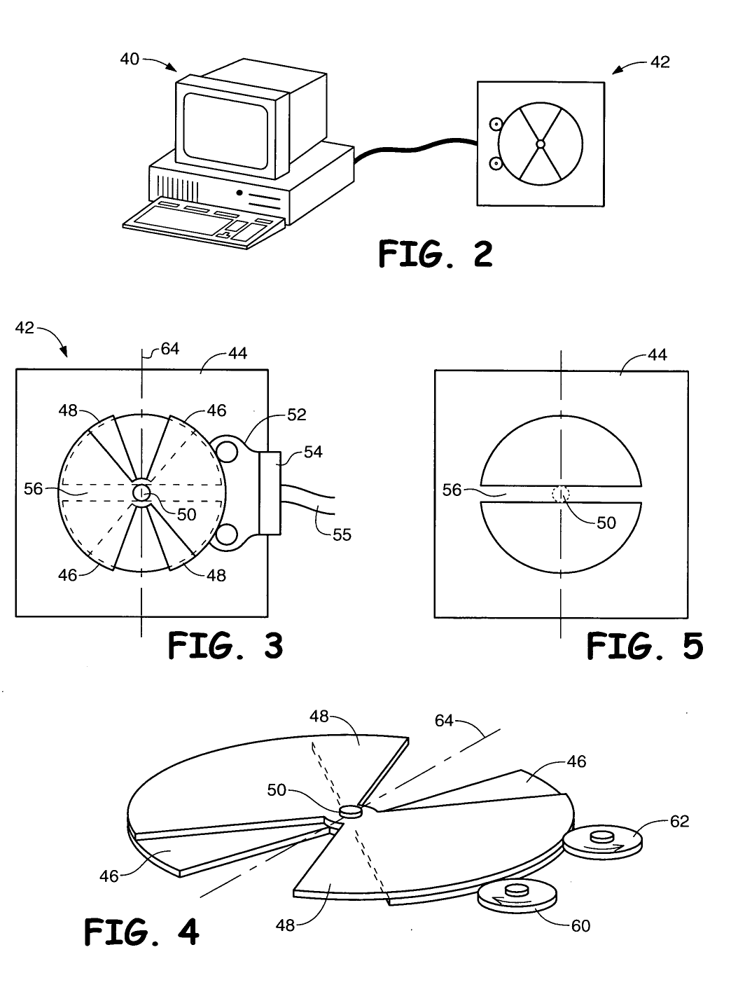

A first embodiment of an inventive blade apparatus for use during the formation of a semiconductor device is depicted schematically in FIG. 2 which depicts a computer 40 which controls an adjustable blade apparatus 42 using settings input by an operator, technician, or engineer.

It should be noted that while the description specifies the use of this embodiment of the invention as a blade, an inventive embodiment may also be used as a diffused optical element (DOE) and the terms are generally interchangeable as used herein. The term “light mask” also is used herein to denote either a blade or a DOE.

An exemplary embodiment of a blade apparatus 42 is depicted in FIG. 3, with detailed views at FIGS. 4 and 5, which comprises: a supporting frame 44; two separate overlapping blade arms 46, 48 which rotate around a central axis 50; and a mechanism 52 which receives an input through a connector 54 attached to a cable 55 from computer 40 for independently controlling each arm 46, 48. The dimensions of the openings through the blade formed by the overlapping arms and the frame are set by the engineer or technician through the use of the controller computer 40. The two arms 46, 48 are attached to the supporting frame 44 at a crossbar 56. In this embodiment, the supporting frame 44 and crossbar 56 are formed from a single piece of metal and the crossbar 56 is formed at a location which will not obstruct the blade openings formed by the arms 46, 48 and frame 44. The arms may also be formed from metal, for example sheet aluminum or steel, from Mylar® supported by a rigid frame, or from another opaque rigid material or an opaque nonrigid material supported by a rigid frame. To minimize light reflectance, the frame, arms, and other portions of the blade apparatus may be flat black in color.

FIG. 4 depicts a detailed view of the exemplary embodiment of FIG. 3. In this embodiment, each blade arm 46, 48 is rotated by a separate gear 60, 62, with both gears being controlled by the computer 40, for example using one electric motor housed in mechanism 52 which controls both gears 60, 62 or with a separate motor for each gear, with each motor being controlled by computer 40. Each gear 60, 62 and the edge of each arm 46, 48 comprises a plurality of intermeshing teeth or other frictional rotation means, which, for simplicity, are not depicted. The teeth of the gear mesh with teeth on the edge of the arm, and the gears are rotated to rotate the arm around the pivot point. While FIG. 4 depicts gears which are laterally spaced as well as vertically spaced, providing the gears such that they are vertically centered with respect to crossbar 56 of FIG. 3 and which have points of rotation centered around a single axis would allow for maximum adjustability of arms 46, 48.

Each gear 60, 62 can rotate both clockwise and counterclockwise, but will generally rotate in opposite directions in matched rotation so that each opening in the blade is centered along a vertical axis 64. In other words, the center of the top and bottom openings, regardless of the angles of the openings, are centered along the vertical axis 64. In this embodiment, the vertical axis 64 is perpendicular to crossbar 56 so that the openings through the blade are not obstructed by crossbar 56.

It may be desirable with some uses of the blade to have off-axis openings, in which case the two gears 60, 62 may rotate in the same direction (both clockwise or counterclockwise) or at unmatched rotational distances to allow an opening having an adjustable axis of rotation (i.e. an axis which can be rotated around the pivot point while maintaining an opening having unchanged dimensions). The maximum angle of the openings is determined by the arcs of each blade arm, the dimensions and configuration of each arm, the placement of the gears 60, 62, and the percent of the arc of each arm which allows rotation by the gear.

In use, the blade (which includes the frame 44 and the arms 46, 48) is inserted into place within the optical lithography equipment as is typically done with conventional blades. If the blade has not been previously connected to the controller computer 40, connection is made, typically with a USB, serial, or parallel cable 55 and connector 54 through which signals pass from the computer 40 through the cable 55 to the gears 60, 62 or to other apparatus adapted to rotate the arms housed with mechanism 52. Mechanism 52 will typically only receive signals from the computer 40 to rotate the arms, although in some uses of the invention mechanism 52 may comprise circuitry which returns information to the computer (for example to ensure that the arms of the blade have reached their desired position) or to directly control the movement of the arms (for example to move the blade through a series of positions based on instructions from the computer). Next, any required initial calibration is performed and the light path provided through the blade by the arms are set to a desired size and axis angle and testing is performed by controlling the rotational position of each arm through the use of the controller 40. The openings of the blade are changed to increase or decrease the area of the openings, to change the rotational axis of the openings, or both, until the openings are optimized. Thus the present invention requires only an initial calibration, then any number of blade settings can be tested without requiring removal of the blade from the photolithographic equipment.

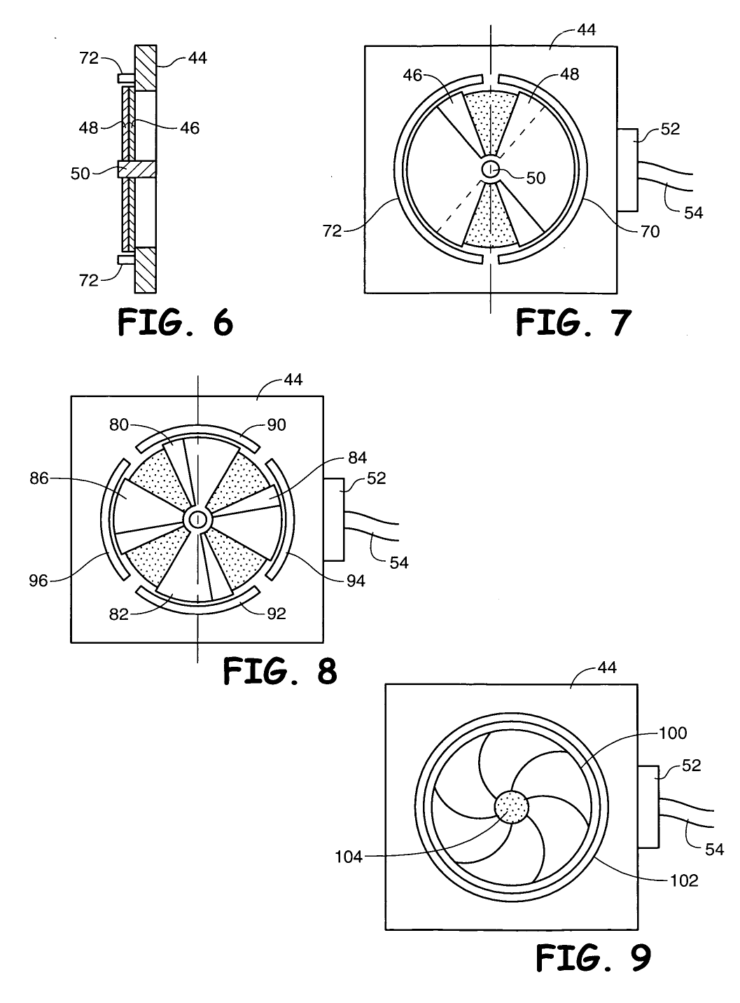

FIG. 6 is a side view, and FIG. 7 is a front view, of a second embodiment of the invention. In this embodiment, one edge of each arm 46, 48 comprises one or more laterally separated magnets, and the arms are rotated to a desired setting using first 70 and second 72 electromagnets. In this exemplary embodiment, arm 46 comprises one or more magnets along the right side and is controlled by electromagnet 70, and arm 48 comprises one or more magnets along the left side and is controlled by electromagnet 72. Two electromagnets are depicted for simplicity, however it may be possible to control the two arms with a single electromagnet, or more than two electromagnets. This embodiment allows control using only electronic means (an electromagnet) rather than the electromechanical means (one or more electric motors and gears) of the first embodiment. Further, this embodiment allows for a larger opening through the blade as the adjustment of the arms does not rely on a gear to mesh with a toothed arc of each arm.

FIG. 8 depicts a blade apparatus for a quadrupole element comprising two sets of arms, with two vertically-oriented arms 80, 82 and two horizontally-oriented arms 84, 86. Arms 80, 82, 84, and 86 are each controlled by electromagnets 88, 90, 92, and 94 respectively.

FIG. 9 depicts a blade apparatus for an annulus comprising an iris shutter 100 and a circular electromagnet 102 for adjusting the size of the aperture 104 in the shutter. In this embodiment, the shutter 100 is manufactured from rigid, opaque sheet metal such as steel or aluminum, and is preferably flat black in color.

Other variations of the adjustable blade are possible. For example, a radial frame may be in which the blade is part of the frame itself in which discrete plates can rotate relative to each other to determine the axis and size of the opening through the blade. Further, mechanisms other than the gear assembly and the electromagnet described herein can be used to adjust the arms of the blade. Also, arrangements other than the dipole element, quadrupole element, and annulus discussed can be manufactured. Two or more blade types, such as an adjustable quadrupole element and an adjustable annulus, may be used together to provide additional patterns.

Automatic setting of the blade will decrease the time the equipment must remain idle, decrease engineering and technician time, and therefore reduce manufacturing costs.

The blade may be used in at least two different methods of optimizing a pattern for a diffractive optical element. In the first use, the blade is configured to a first position by forming at least one light path through the blade. A coherent light source is then patterned by the light path through the blade, which then provides a first exposure of an optical pattern. Based on the results from the first exposure, the arms of the blade are adjusted to alter the light path through the blade, then the light path is patterned by the blade to provide a second exposure of the optical pattern. This process of exposure, measurement, blade adjustment, and exposure is continued until the opening in the blade is optimized, wherein a sufficient DOE is then ordered or manufactured. In the second use, prior to using the blade a number of possible openings through the blade are predetermined. The possible openings may be programmed into the controller computer or they can be manually set prior to each measurement. In either case, the blade is adjusted to the first setting, the coherent light source is patterned by the blade, the first exposure is performed using the patterned light source, then the blade is adjusted to the second setting and the second exposure is performed. This process of exposure, blade adjustment, exposure is performed until all predetermined blade positions are used to expose the pattern. The results are then analyzed to determine the desired DOE pattern, which is then ordered or manufactured.

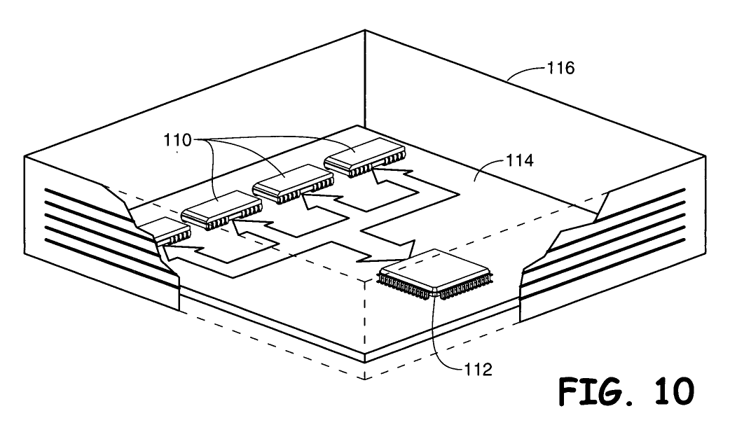

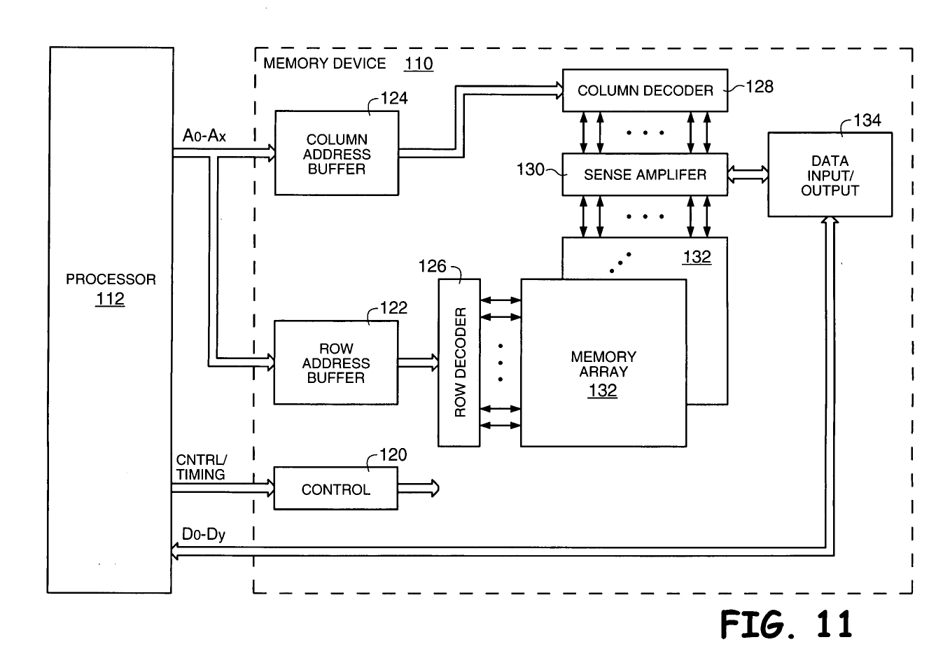

As depicted in FIG. 10, a semiconductor device 110 formed in accordance with the invention may be attached along with other devices such as a microprocessor 112 to a printed circuit board 114, for example to a computer motherboard or as a part of a memory module used in a personal computer, a minicomputer, or a mainframe 116. FIG. 16 may also represent use of device 110 in other electronic devices comprising a housing 116, for example devices comprising a microprocessor 112, related to telecommunications, the automobile industry, semiconductor test and manufacturing equipment, consumer electronics, or virtually any piece of consumer or industrial electronic equipment.

The process and structure described herein can be used to manufacture a number of different semiconductor structures. In a semiconductor memory device, these structures may comprise a capacitor such as a container capacitor or a pedestal capacitor. FIG. 11, for example, is a simplified block diagram of a memory device 110 such as a dynamic random access memory having a memory array with container capacitors which may be formed using an embodiment of the present invention. The general operation of such a device is known to one skilled in the art. FIG. 11 depicts a processor 112 coupled to a memory device 110, and further depicts the following basic sections of a memory integrated circuit: control circuitry 120; row 122 and column 124 address buffers; row 126 and column 128 decoders; sense amplifiers 130; memory array 132; and data input/output 134.

While this invention has been described with reference to illustrative embodiments, this description is not meant to be construed in a limiting sense. Various modifications of the illustrative embodiments, as well as additional embodiments of the invention, will be apparent to persons skilled in the art upon reference to this description. It is therefore contemplated that the appended claims will cover any such modifications or embodiments as fall within the true scope of the invention.

What is claimed is:

1. A method used to shape a light pattern produced by an optical lithography apparatus, comprising:
producing a coherent light source;
projecting the coherent light source onto an adjustable light mask having at least one opening therein to produce a light pattern;
measuring the light pattern; and
adjusting the adjustable light mask to alter the opening in the light mask based on the measurement of the light pattern.

2. The method of claim 1 wherein:
the adjustable light mask comprises:
a frame;
an arm; and
a pivot point wherein the arm is connected to the frame at the pivot point; and
subsequent to measuring the light pattern, the method further comprises rotating the arm around the pivot point to move the arm in relation to the frame, wherein rotating the arm adjusts a size of the opening in the light mask.

3. The method of claim 2 further comprising:
providing at least one electromagnet adjacent to the arm; and
altering an electrical signal to the electromagnet to rotate the arm around the pivot point.

4. The method of claim 2 further comprising:
providing a plurality of teeth on an edge of the arm;
providing a toothed gear which meshes with teeth on the edge of the arm; and
rotating the toothed gear to rotate the arm around the pivot point.

5. The method of claim 2 further comprising:
providing the frame comprising two openings therein separated by a crossbar, wherein the crossbar is formed in a single piece with the frame; and
providing the pivot point on the crossbar.

6. The method of claim 2 further comprising providing the adjustable light mask comprising an arm formed from a nonrigid, opaque material.

7. The method of claim 1 further comprising:
providing the adjustable light mask which comprises:
a frame having at least one opening therein; and
first and second arms, wherein the arms are rotatable in opposite directions with respect to each other to provide at least one adjustable opening through the arms.

8. The method of claim 7 further comprising providing the first and second arms, wherein the arms are rotatable in the same direction with respect to each other to provide opening having an adjustable axis of rotation.

9. A method for developing a diffractive optical element for use during the manufacture of a semiconductor device, comprising:
inserting a blade into a light source path, wherein the blade comprises:
at least first and second arms; and
a single pivot point around which both the first and second arms rotate;
rotating at least one arm around the pivot point to align the first arm with the second arm to provide an opening through the blade, wherein the opening through the blade has a size and a rotational alignment;
providing a light source into the light source path, wherein the light source passes through, and is patterned by, the opening through the blade;
measuring the light source at a location after it passes through, and is patterned by, the opening through the blade;
based on the measurement, rotating at least one arm around the pivot point to alter at least one of the size and the rotational alignment of the opening through the blade;
subsequent to altering at least one of the size and the rotational alignment of the opening through the blade, providing a light source into the light source path, wherein the light source passes through, and is patterned by, the altered opening through the blade;
measuring the light source at a location after it is patterned by the altered opening through the blade; and
based on the measurement of the light source which is patterned by the altered opening through the blade, forming a diffractive optical element.

10. The method of claim 9 further comprising:
providing at least one electromagnet adjacent to the first arm; and
altering an electrical signal to the electromagnet to rotate the first arm around the pivot point.

11. The method of claim 10 further comprising:
providing a plurality of teeth on an edge of the first arm;
providing a toothed gear which meshes with teeth on the edge of the first arm; and
rotating the toothed gear to rotate the first arm around the pivot point.

12. The method of claim 9 wherein the first and second arms are both rotatable in opposite directions with respect to each other.

13. The method of claim 9 wherein the first and second arms are both rotatable in the same direction with respect to each other to provide an opening through the blade having an adjustable axis of rotation.

14. The method of claim 9 further comprising a plurality of rotatable arms as a part of an iris shutter, wherein rotating the arms alters a radius of a circular opening through a center of the blade.

15. A method for exposing a surface to a shaped light source, comprising:
placing a light mask having a shaped path through which light can travel into a photolithography apparatus;
passing a light source through the shaped path in the light mask to shape the light source with a first pattern;
exposing the surface to the shaped light source having the first pattern;
subsequent to exposing the surface to the shaped light source having the first pattern and while the light mask remains within the photolithography apparatus, altering the dimensions of the shaped path in the light mask;
passing the light source through the altered shaped path in the light mask to shape the light source with a second pattern; and
exposing the surface to the shaped light source having the second pattern.

16. An optical lithography apparatus comprising:
a blade located in the path of a light source, wherein the blade comprises:
at least first and second arms each comprising at least one opening therein; and
a single pivot point around which both the first and second arms can rotate, wherein the opening in the first arm is aligned with the opening in the second arm to provide an opening through the blade,
wherein the opening in the blade is optimized for a specific pattern to be exposed by the blade.

17. The optical lithography apparatus of claim 16 further comprising a first electromagnet adjacent to the first blade and a second electromagnet adjacent to the second blade.

18. The optical lithography apparatus of claim 16 further comprising:
the first arm comprising a plurality of teeth located around an edge of the first arm;
the second arm comprising a plurality of teeth located around an edge of the second arm;
a first gear having teeth which mesh with the teeth of the first arm; and
a second gear having teeth which mesh with the teeth of the second arm.

19. The optical lithography apparatus of claim 16 further comprising:
a controller computer adapted to adjust the first and second arms of the blade to adjust the size of the opening through the blade.
